(19) United States
(12) Patent Application Publication
(10) Pub. No.: US 2013/0118769 A1
(43) Pub. Date: May 16, 2013

(54) AIR PRESSURE REUSED PNEUMATIC HAMMER DRILL

(71) Applicant: Chin-Yi LEE, Taoyuan County (TW)

(72) Inventor: Chin-Yi LEE, Taoyuan County (TW)

(21) Appl. No.: 13/297,729

(22) Filed: Nov. 16, 2011

(51) Int. Cl. B23B 35/00

(52) U.S. Cl. 173/218

(57) ABSTRACT

An air pressure reused pneumatic hammer drill comprises a rotary driven head, a housing and a ground entry and operation unit which includes a pneumatic hammer duct to hold a hollow pneumatic hammer piston and a drill, an integrated hood with an air cycling chamber communicating with the pneumatic hammer duct, a stone discharge duct which has a first stone and air discharge duct at an upper side communicating therewith, a discharge air inlet running through the integrated hood and communicating with the air cycling chamber, and an air discharge duct communicating with the discharge air inlet and the first stone and air discharge duct. The discharge air inlet and the air discharge duct are interposed by a check valve. Thus the invention not only can save electricity resource to reduce cost, but also can shorten working hours to save manpower to meet requirements in engineering industry.

### FIELD OF THE INVENTION

The present invention relates to a drill to drill stratum and particularly to a pneumatic hammer drill to drive a heavy hammer via air pressure to generate a downward force to strike a drill to drill holes.

### BACKGROUND OF THE INVENTION

R.O.C. patent No. 1278559 entitled “Laccolith drilling apparatus” discloses that the apparatus is driven by a rotational power source and incorporates with weight thereof and reciprocating vibration of a pneumatic unit to drive a drill to constantly downward strike rock laccolith to do drilling. The apparatus includes a coupler to provide spinning transmission and air intake vibration, a coupling duct with one end coupled on a lower end of a coupler shaft and also connected to a connector which in turn couples with a pneumatic unit to drive a coupled drill. The pneumatic unit drives the drill to vibrate and reciprocate to constantly downward strike the rock laccolith.

However, in the conventional techniques the pressurized air cannot be reused once it has driven the drill vibrating. This results in waste of electricity resource. Moreover, after the drill has stricken the rock laccolith into gravel, the gravel and mud have to be channeled into an excavator, and the entire apparatus has to be removed form the work well aside and maintained rotating, so that the excavator would be opened to fully dump the gravel and mud. The process wastes a lot of time and often causes project delay, and results in higher labor cost. It cannot meet requirements of short time limit for a project and lower labor and material costs.

### SUMMARY OF THE INVENTION

The primary object of the present invention is to provide an air pressure reused pneumatic hammer drill that not only can save electricity resource to reduce cost but also can shorten working hours to save manpower to meet requirements in engineering industry.

To achieve the foregoing object, the air pressure reused pneumatic hammer drill provided by the invention includes a rotary driven head which is driven to rotate by an external force, includes an air intake duct, and also is run through by a second stone and air discharge duct; a housing which encases the rotary driven head and has an air inlet communicating with the air intake duct, a transitional space formed therein and communicating with the second stone and air discharge duct, and a stone and air discharge outlet communicating with the transitional space; and a ground entry and operation unit which is driven by the rotary driven head and includes a guide duct communicating with the air intake duct. The ground entry and operation unit further includes a pneumatic hammer duct which communicates with the guide duct and holds a hollow pneumatic hammer piston and a drill partly extended outside thereof to receive striking of the pneumatic hammer piston, an integrated hood which includes an air cycling chamber communicating with and fastened to the pneumatic hammer duct, a stone discharge duct which is fastened to the integrated hood and juxtaposed with the pneumatic hammer duct and has a discharge stone inlet at a lower side leading to the exterior and a first stone and air discharge duct at an upper side communicating with the stone discharge duct and also communicating with the second stone and air discharge duct, a discharge air inlet running through the integrated hood and communicating with the air cycling chamber, and an air discharge duct communicating with the discharge air inlet and the first stone and air discharge duct. The discharge air inlet and the air discharge duct are interposed by a check valve.

By means of the structure set forth above, when the pneumatic hammer piston is pushed by air pressure and strikes the drill, the air pressure passes through the air cycling chamber and discharge air inlet to push the check valve away and enter the air discharge duct and the first and second stone and air discharge ducts, and then is ejected through the stone and air discharge outlet to quickly carry the gravel and mud outside. The invention not only saves electricity resource to reduce cost, but also shortens working hours to meet requirements in engineering industry.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the invention.

FIG. 2 is another perspective view according to FIG. 1 from another viewing angle.

FIG. 3 is a sectional view according to FIG. 1.

FIG. 4 is an enlarged fragmentary view of an upper section according to FIG. 3 showing air pressure flow.

FIG. 5 is an enlarged fragmentary view of a lower section according to FIG. 3 showing stone discharge via air pressure flow.

FIG. 6 is an enlarged fragmentary view according to FIG. 5 showing air pressure flow.

FIG. 7 is an enlarged fragmentary view of an upper section according to FIG. 3 showing stone discharge via air pressure flow.

### DETAILED DESCRIPTION OF THE PREFERRED EMBODIMENTS

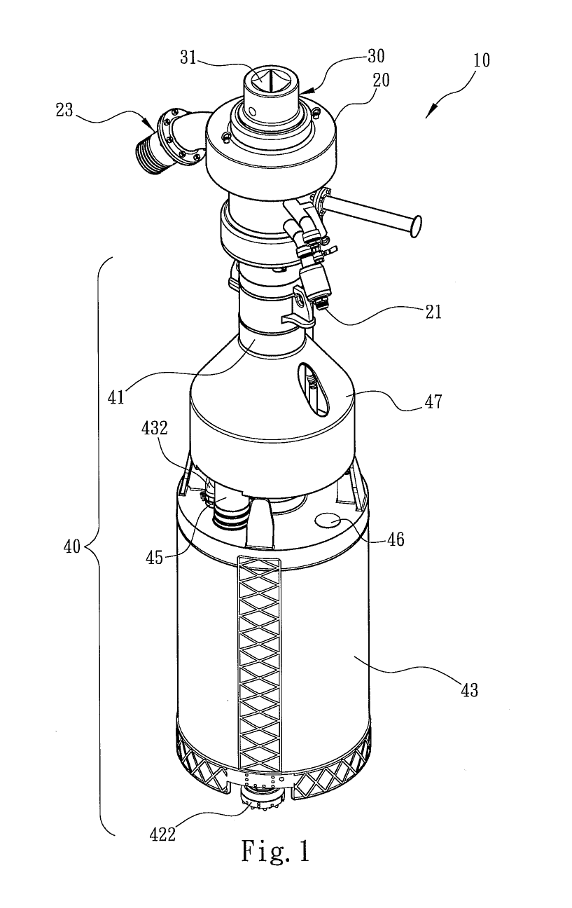

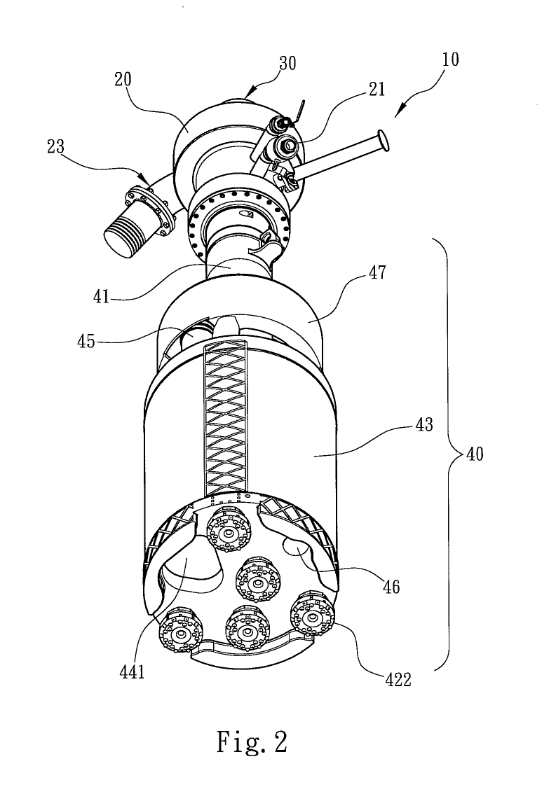

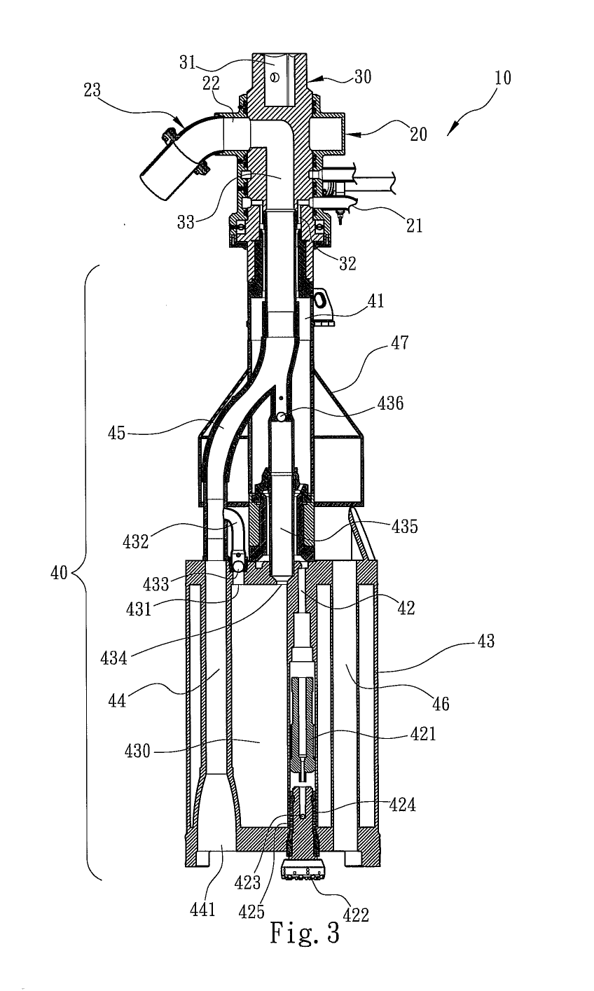

Please refer to FIGS. 1, 2 and 3, the present invention aims to provide a pneumatic hammer drill 10 which includes a rotary driven head 30 driven to rotate by an external force and run through by a second stone and air discharge duct 33, and containing an air intake duct 32 and a driven portion 31 at the top connected to a rotary external power source; a housing 20 encasing the rotary driven head 30 and containing an air inlet 21 communicating with the air intake duct 32, a transitional space 22 formed therein communicating with the second stone and air discharge duct 33, and a stone and air discharge outlet 23 communicating with the transitional space 22; and a ground entry and operation unit 40 which is driven by the rotary driven head 30 and contains a guide duct 41 communicating with the air intake duct 32. The guide duct 41 is encased by a conical guiding hood 47. The ground entry and operation unit 40 further includes a pneumatic hammer duct 42 communicating with the guide duct 41 and holding a hollow pneumatic hammer piston 421 and a drill 422 partly extended outside the pneumatic hammer duct 42 to receive striking of the pneumatic hammer piston 421. The drill 422 is coupled with a spring 424 to buffer the striking action of the pneumatic hammer piston 421 and has an air discharge port 423 spaced from the spring 424 to communicate with the pneumatic hammer duct 42. The pneumatic hammer duct 42 further has an orifice 425 opposing the spring 424 and communicating with an air cycling chamber 430. The ground entry and operation unit 40 also has an integrated hood 43 which includes the air cycling chamber 430 and communicates with and fastens to the pneumatic hammer duct 42, and a stone discharge duct 44 fastened to the integrated hood 43 and juxtaposed with the pneumatic hammer duct 42. The stone discharge duct 44 has a discharge stone inlet 441 at a lower side leading to the exterior and a first stone and air discharge duct 45 at an upper side communicating therewith. The first stone and air discharge duct 45 communicates with the second stone and air discharge duct 33. The ground entry and operation unit 40 further has a discharge air inlet 431 running through the integrated hood 43 and communicating with the air cycling chamber 430 and an air discharge duct 432 communicating with the discharge air inlet 431 and the first stone and air discharge duct 45. The discharge air inlet 431 and air discharge duct 432 are interposed by a check valve 433. The ground entry and operation unit 40 further has a through duct 46 running through the integrated hood 43 and juxtaposing with the pneumatic hammer duct 42, an ancillary discharge air inlet 434 running through the integrated hood 43 and communicating with the air cycling chamber 430, and an ancillary air discharge duct 435 communicating with the ancillary discharge air inlet 434 and the first stone and air discharge duct 45. The ancillary air discharge duct 435 and the first stone and air discharge duct 45 are jointed at a junction that is located at an elevation higher than that of another junction of the air discharge duct 432 and the first stone and air discharge duct 45. The ancillary discharge air inlet 434 and the ancillary air discharge duct 435 are interposed by an ancillary check valve 436 at an elevation higher than the check valve 433.

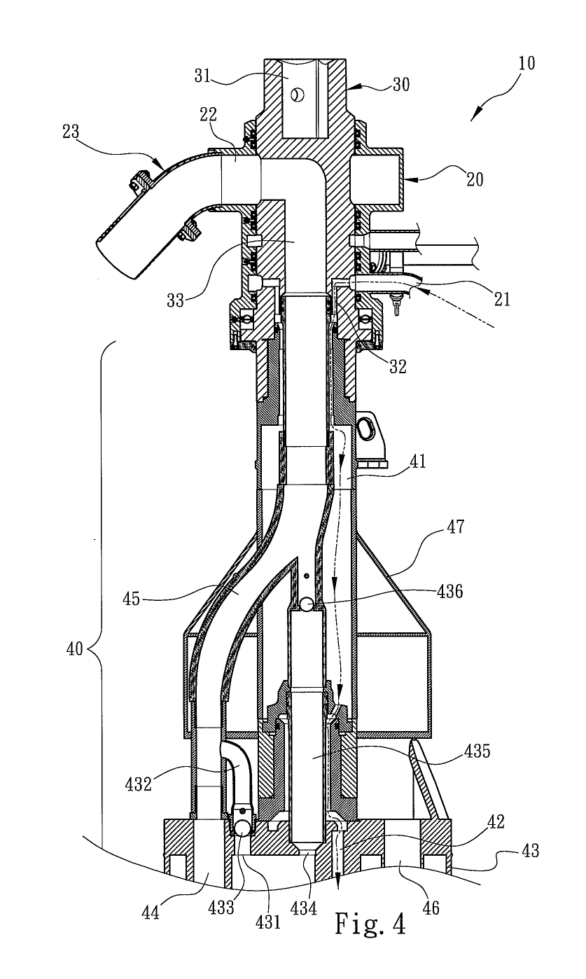

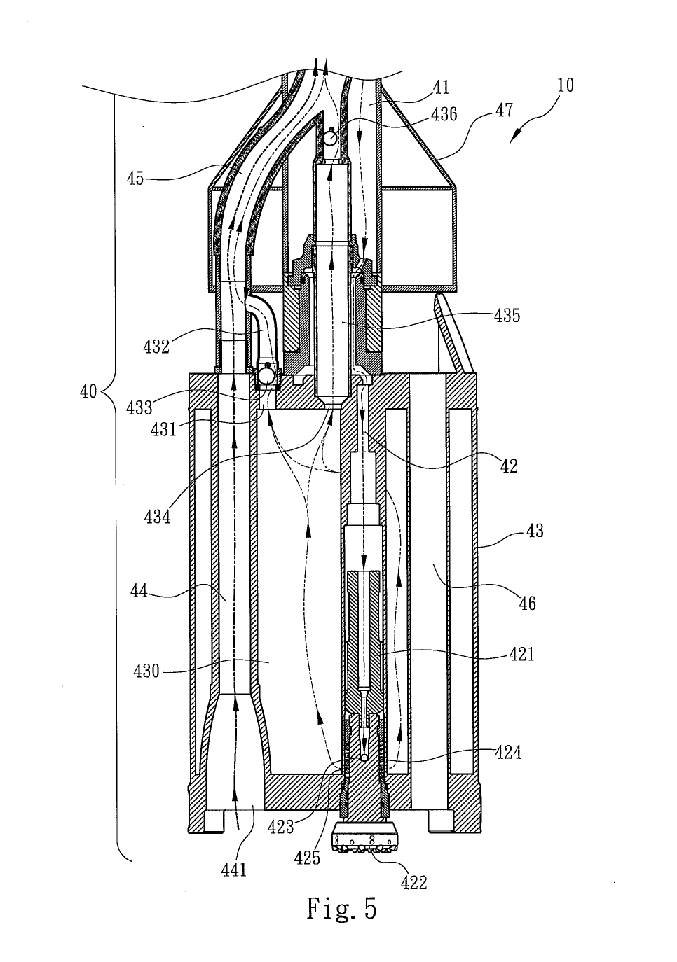

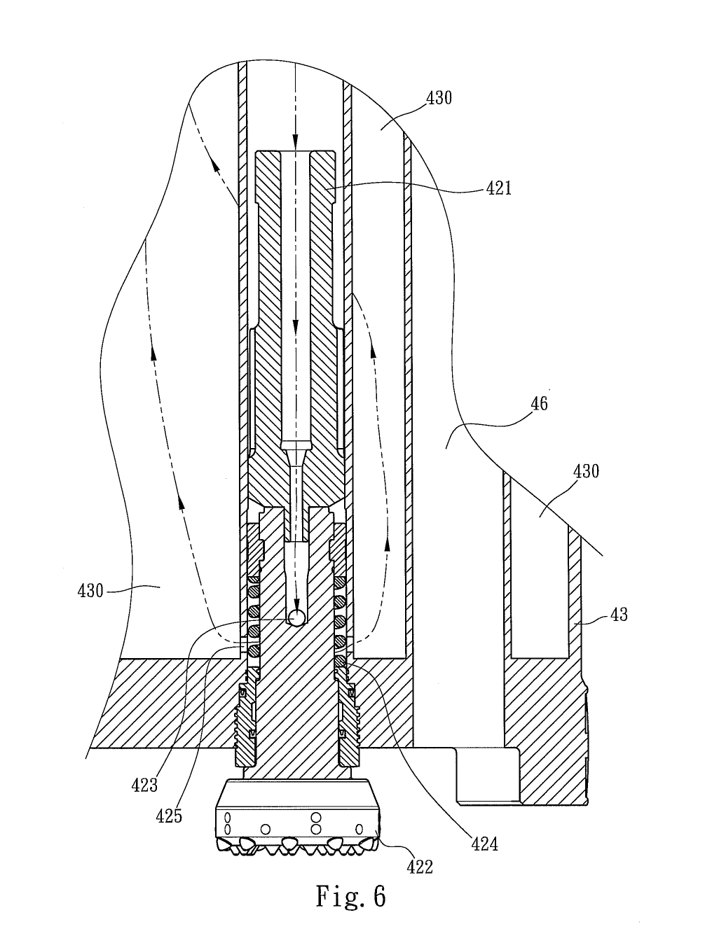

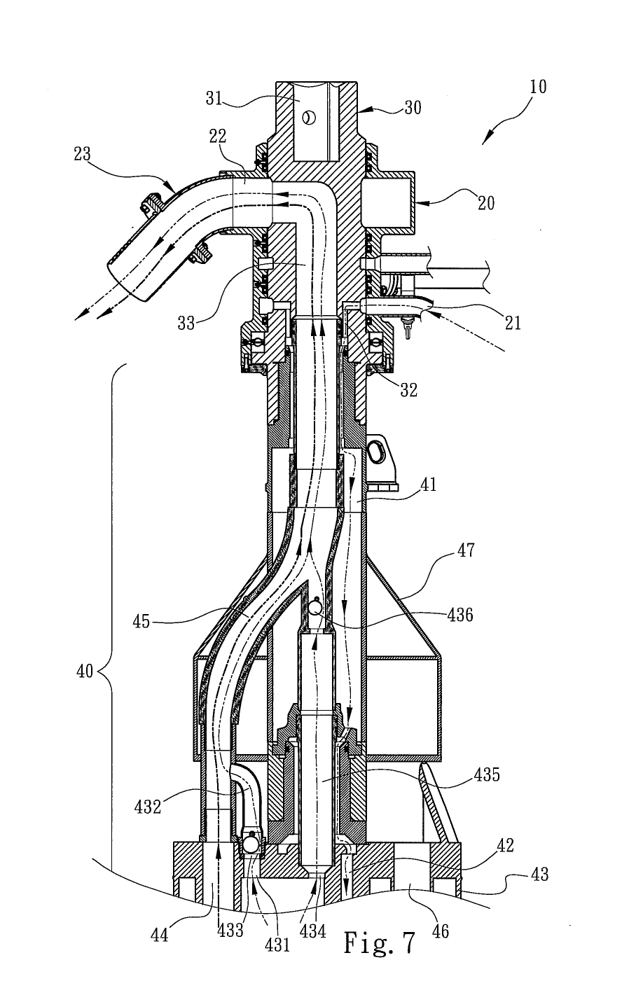

Referring to FIGS. 4 through 7, when pressurized air enters through the air inlet 21 to form flowing air pressure, the air pressure flows to the pneumatic hammer duct 42 via the guide duct 41 as shown in FIG. 4; the air pressure pushes the pneumatic hammer piston 421 to strike the drill 422; due to the drill 422 is coupled with the spring 424, under the constant air pressure of the pneumatic hammer piston 421 the drill 422 generates reciprocal up and down striking movements; collaborating with the rotation of the rotary driven head 30 driven by the external force, a work shaft can be drilled and formed. As the pneumatic hammer piston 421 is hollow, the air pressure can pass through the air discharge port 423 and orifice 425 to flow into the air cycling chamber 430 as shown in FIGS. 5 and 6; the air pressure in the air cycling chamber 430 can be reused by flowing through the discharge air inlet 431 and ancillary discharge air inlet 434 to push the check valve 433 and ancillary check valve 436 away, and flow to the air discharge duct 432 and ancillary air discharge duct 435 to enter the first and second stone and air discharge ducts 45 and 33 to carry gravel and mud below the discharge stone inlet 441 upwards so that the gravel and mud can be carried by the air pressure flow to the stone and air discharge outlet 23 to be ejected outside as shown in FIG. 7. Thus the air pressure can be reused as desired.

What is claimed is:

1. An air pressure reused pneumatic hammer drill, comprising:
a rotary driven head which is driven to rotate by an external force and run through by a second stone and air discharge duct and includes an air intake duct;
a housing which encases the rotary driven head and includes an air inlet communicating with the air intake duct, a transitional space formed therein and communicating with the second stone and air discharge duct, and a stone and air discharge outlet communicating with the transitional space; and
a ground entry and operation unit which is driven by the rotary driven head and includes a guide duct communicating with the air intake duct, a pneumatic hammer duct which communicates with the guide duct and holds a hollow pneumatic hammer piston and a drill partly extended outside thereof to receive striking of the pneumatic hammer piston, an integrated hood which includes an air cycling chamber and is fastened to the pneumatic hammer duct and communicates therewith, a stone discharge duct which is fastened to the integrated hood and juxtaposed with the pneumatic hammer duct and includes a discharge stone inlet at a lower side leading to the exterior and a first stone and air discharge duct at an upper side communicating therewith and communicating with the second stone and air discharge duct, a discharge air inlet running through the integrated hood and communicating with the air cycling chamber, and an air discharge duct communicating with the discharge air inlet and the first stone and air discharge duct, the discharge air inlet and the air discharge duct being interposed by a check valve.

2. The air pressure reused pneumatic hammer drill of claim 1, wherein the ground entry and operation unit further includes a through duct running through the integrated hood and juxtaposing with the pneumatic hammer duct.

3. The air pressure reused pneumatic hammer drill of claim 1, wherein the ground entry and operation unit further includes an ancillary discharge air inlet running through the integrated hood and communicating with the air cycling chamber and an ancillary air discharge duct communicating with the ancillary discharge air inlet and the first stone and air discharge duct, the ancillary air discharge duct and the first stone and air discharge duct being jointed at a junction that is located at an elevation higher than that of another junction of the air discharge duct and the first stone and air discharge duct, the ancillary discharge air inlet and the ancillary air discharge duct being interposed by an ancillary check valve located at an elevation higher than that of the check valve.

4. The air pressure reused pneumatic hammer drill of claim 2, wherein the ground entry and operation unit further includes an ancillary discharge air inlet running through the integrated hood and communicating with the air cycling chamber and an ancillary air discharge duct communicating with the ancillary discharge air inlet and the first stone and air discharge duct, the ancillary air discharge duct and the first stone and air discharge duct being jointed at a junction that is located at an elevation higher than that of another junction of the air discharge duct and the first stone and air discharge duct, the ancillary discharge air inlet and the ancillary air discharge duct being interposed by an ancillary check valve located at an elevation higher than that of the check valve.

5. The air pressure reused pneumatic hammer drill of claim 4, wherein the drill is coupled with a spring to buffer the striking of the pneumatic hammer piston and includes an air discharge port spaced from the spring and communicating with the pneumatic hammer duct, the pneumatic hammer duct including an orifice opposing the spring and communicating with the air cycling chamber.
